(19) United States
(12) Patent Application Publication
(10) Pub. No.: US 2010/0193307 A1
(43) Pub. Date: Aug. 5, 2010

(54) HYDRODYNAMIC RETARDER WITH A TANGENTIAL INFLOW AND OUTFLOW PRINCIPLE

(75) Inventors: Thomas Meid, Deggenhausertal (DE); Andreas Ulmer, Friedrichshafen (DE); Michael Huber, Langenargen (DE); Peter Weissenrieder, Meckenbeuren (DE); Stefan Krause, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/665,101

(22) PCT Filed: Jun. 19, 2008
(86) PCT No.: PCT/EP2008/057756

§ 371 Date: Dec. 17, 2009

(30) Foreign Application Priority Data
Jul. 6, 2007 (DE) 10 2007 031 723.0

(51) Int. Cl. F16D 57/04; F16D 57/00

(52) U.S. Cl. 188/296

(57) ABSTRACT

A hydrodynamic retarder with tangential inflow and outflow is formed with at least one radial recess (3), in the stator, which extends radially outward when viewed in the radial direction. The at least one radial recess (3) is arranged so as to enable one of back-feed and back-filling of the oil, emerging through the tangential outlet, into the pressure space.

This application is a National Stage completion of PCT/EP2008/057756 filed Jun. 19, 2008, which claims priority from German patent application serial no. 10 2007 031 723.0 filed Jul. 6, 2007.

### FIELD OF THE INVENTION

The present invention relates to a hydrodynamic retarder operating with tangential inflow and outflow.

### BACKGROUND OF THE INVENTION

In hydrodynamic retarders the flow energy of a liquid is used for braking, the physical action principle, corresponding to that of a hydrodynamic clutch with a fixed turbine. According to this, a hydrodynamic retarder comprises a rotor positioned in the power flow and a stator fixedly connected to the retarder housing. When the retarder is actuated, a quantity of oil, corresponding to the braking power desired, is introduced into the blade space so that the spinning rotor accelerates the oil and transfers it to the stator. This results in a braking effect on the rotor shaft.

In the case of hydrodynamic retarders that operate with tangential inflow and outflow, when the retarder is partially filled, i.e. filled with a small quantity of oil, the medium flowing in drains out again directly through the tangential outlet without completing or closing the hydrodynamic circuit. To achieve a small change of the braking torque, in such an operating range a large change of the associated control pressure is needed.

If the filling of the retarder is increased, then from a certain filling level onward the hydrodynamic circuit is closed and when this is so, only small control pressure changes are needed in order to produce large braking torque changes.

Thus, in hydrodynamic retarders with tangential inflow and outflow there are two different operating ranges, and at the transition between the two ranges an instability occurs which leads to marked fluctuations of the braking torque, since at that operating point there is frequent alternation between a closed and an open hydrodynamic circuit.

From DE 4028128 A1 by the present applicant a device for reducing idling losses in hydrodynamic brakes is known, in which, to reduce ventilation losses, adjustable flow impeders are arranged between the rotor and the stator of the brake. In this case, during idling operation with a brake empty of oil, one or more flow impeders in the outer area of the torus spaces, for example with angled cross-sections, separate those spaces by means of an annular leg projecting radially inward, and a leg arranged cylindrically in the axial direction is in contact with the inner wall of a chamber.

During braking operation of the known brake, the front edge of the radially inward-projecting leg is behind the torus spaces; if only one flow impeder is provided, which covers the entire circumference of the outer area of the torus spaces, then to achieve the requisite elasticity, slits are formed in the radially inward-projecting leg. Actuation to the radially outer and inner end positions is achieved by means of an actuating device, a particularly advantageous design for this being a piston-cylinder unit with two pistons and with a carrier device on the pistons and carriers on the flow impeder; in this case the inner position is reached by means of springs and the outer position by virtue of the pressure of a pressure medium in a pressure space between the two pistons.

### SUMMARY OF THE INVENTION

The purpose of the present invention is to propose a hydrodynamic retarder with tangential inflow and outflow, in which the instability between the two operating ranges is largely avoided.

According to these, a hydrodynamic retarder with tangential inflow and outflow is proposed, in which a closed hydrodynamic circuit is produced even with only partial filling in some areas.

In this way the tangential outflow in the areas is restricted, but without conflicting with the functional principle of tangential outflow. In turn, this results in avoidance of the unstable operating range.

According to the invention this is achieved by forming at least one radial recess in the stator of the hydrodynamic retarder, which extends along the periphery (outward as viewed radially), and the depth and width or extension of the radial recess can be varied.

Thanks to the recess formed according to the invention, in the event of partial filling a back-feed or back-filling of the oil emerging through the tangential outlet of the retarder, into the pressure space, is made possible and by virtue of this the hydrodynamic circuit is closed. In the stable operating range of the retarder, when demands are high, the recesses have a negligible influence.

### BRIEF DESCRIPTION OF THE DRAWINGS

Below, an example of the invention is explained in greater detail with reference to the attached figures, which show:

FIG. 1: Partial view of the pressure side of a stator blade, to illustrate the invention;

FIG. 2: Schematic plan view of the blade wheel of the stator, according to a preferred embodiment of the invention;

FIG. 3: Schematic side-view of the blade wheel shown in FIG. 2; and

FIG. 4: View of part of the blade wheel of the stator, looking outward from the center of the pressure space of the retarder.

### DETAILED DESCRIPTION OF THE PREFERRED EMBODIMENTS

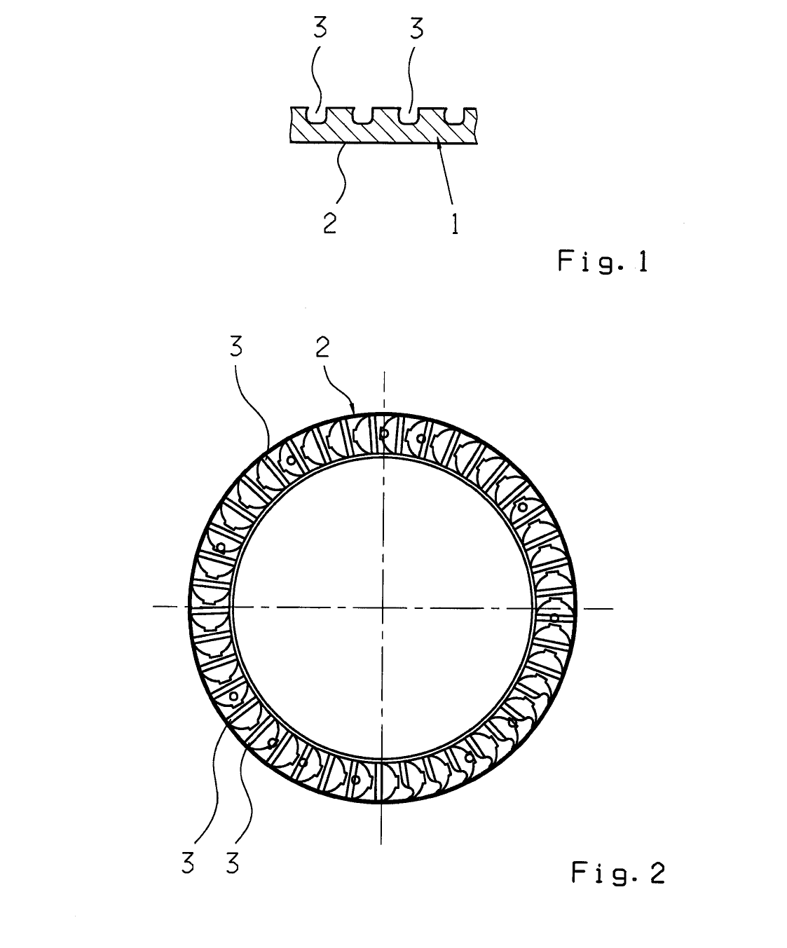

FIG. 1 shows part of the pressure side 1 of the blade wheel 2 of the stator of a hydrodynamic retarder, in which, according to the invention, radial recesses 3 are provided, which extend radially outward. In the event of partial filling, this enables a back-feed or back-filling of the oil emerging through the tangential outlet, into the pressure space. The amount of back-feeding can be determined or adjusted by the number and dimensions of the recesses.

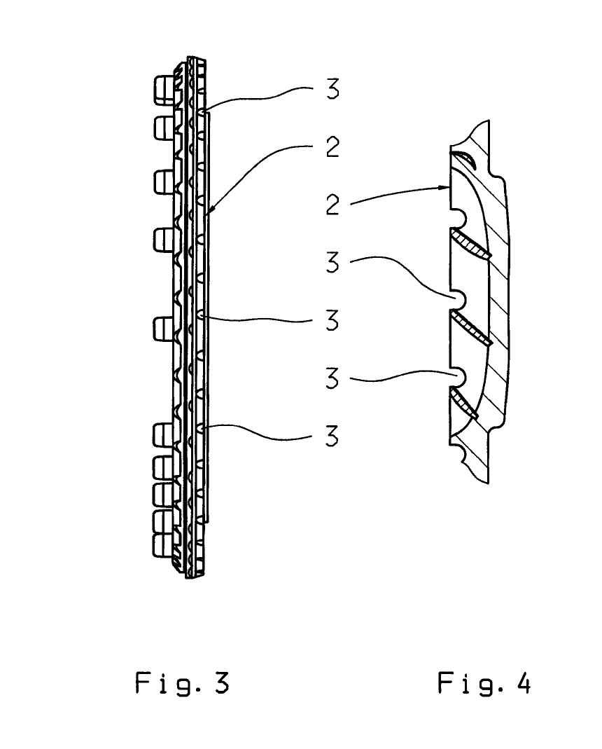

FIG. 2 shows a schematic plan view of a blade wheel 2 of a stator made according to the invention, in which a plurality of equally-sized recesses 3 are distributed symmetrically around the periphery. The corresponding side-view of the blade wheel 2 is shown in FIG. 3.

FIG. 4 is a view of the blade wheel 2 designed according to the invention, looking outward from the center of the pressure space of the retarder. In the figures shown, the recesses 3 are arranged symmetrically around the periphery of the blade wheel 2 and are all the same size. However, the recesses 3 can be distributed or positioned asymmetrically. Moreover, the dimensions of individual recesses 3 can be different. In addition, the diameter of the recesses 3 can very along their length.

### INDEXES

1 Pressure side
2 Blade wheel
3 Recess

1-6. (canceled)

7. A hydrodynamic retarder with tangential inflow and outflow,
wherein a stator of the hydrodynamic retarder has at least one radial recess (3) is formed therein, the at least one radial recess (3), when viewed radially, extends outward in such a manner that in the event of partial filling, either a back-feed or back-filling of oil emerging through a tangential outlet of the retarder, into a pressure space, is possible.

8. The hydrodynamic retarder with tangential inflow and outflow according to claim 7, wherein a degree of back-feeding is at least one of determined and adjusted by virtue of a number and dimensions of the recesses (3).

9. The hydrodynamic retarder with tangential inflow and outflow according to claim 7, wherein the recesses (3) are arranged one symmetrically and asymmetrically around a periphery of a blade wheel (2).

10. The hydrodynamic retarder with tangential inflow and outflow according to claim 7, wherein the recesses (3) have equal dimensions.

11. The hydrodynamic retarder with tangential inflow and outflow according to claim 7, wherein the recesses (3) have different dimensions.

12. The hydrodynamic retarder with tangential inflow and outflow according to claim 7, wherein the diameter of the recesses (3) varies along a length thereof.

13. A Hydrodynamic retarder with tangential inflow and outflow, the retarder comprising:
a stator having a plurality of radial recesses (3) which extend radially outward such that when partially filled, oil flowing through a tangential outlet of the retarder is one of back-fed and back-filled into a pressure space of the retarder, with an amount of the oil being one of back-fed and back-filled into the pressure space being dependent on a quantity and size of the plurality of channels (3).
